(19) United States
(12) Patent Application Publication
(10) Pub. No.: US 2005/0214639 A1
(43) Pub. Date: Sep. 29, 2005

(54) Electrical contact element for alkaline cells

(76) Inventor: Kari Terho, Sherwood, WI (US)

Correspondence Address: MORGAN & FINNEGAN, L.L.P., 3 WORLD FINANCIAL CENTER, NEW YORK, NY, 10281-2101, US

(21) Appl. No.: 10/810,191

(22) Filed: Mar. 26, 2004

(51) Int. Cl. H01M 2/26; H01M 4/66

(52) U.S. Cl. 429/161; 429/245

(57) ABSTRACT

The invention relates to an electrical contact element for an alkaline electrochemical cell. The electrical contact element is made of a copper tin alloy containing 0,05-1,5% by weight tin.

This invention relates to an electrical contact element to be used in alkaline electrochemical cells, which electrical contact element is made of a copper tin alloy.

In alkaline electrochemical cells a manganese dioxide is usually used as a cathode material and zinc as an anode material. The shape of alkaline electrochemical cells is generally cylindrical. The cathode material is so shaped advantageously for instance by pressing that the cathode material forms a casing for the cell. The cavity of this preferably cylindrical cathode is fitted with a separator material. The separator-lined cavity is filled with the anode material. The open end of the cell casing is then provided with a cover having a centrally located hole preferably by crimping the cover in place. Through the hole in the cover an electrical contact element is fitted into the zinc anode material. The top of the electrical contact element extends above the cover. These kinds of alkaline cells are often connected in series to form higher voltage batteries.

Many different materials are used in forming the electrical contact element, which often is in the shape of a nail. One common material for the electrical contact element is brass having a composition of 70% by weight copper and 30% by weight zinc. The U.S. Pat. No. 4,791,036 describes a material of a silicon bronze alloy that contains 85-98% by weight copper and 1-5% by weight silicon with the remainder containing at least one of manganese, iron, zinc, aluminum, tin, lead or mixtures thereof.

The alloy of the U.S. Pat. No. 4,791,036 gives an advantageous value of resistance for the electrical contact element, but the alloy of the U.S. Pat. No. 4,791,036 has its limitations to realize the need to manufacture the cells more cost-effectively and to manufacture the cells lighter than in the past.

The object of the present invention is then to eliminate some drawbacks of the prior art and to achieve an improved electrical contact element to be used in alkaline cells so that the material need for electrical contact element is less than for the alloy of the prior art. The essential features of the invention are enlisted in the appended claims.

According to the invention the electrical contact element to be used in alkaline electrochemical cells is manufactured of a copper alloy containing 0,05 to 1,5% by weight tin, preferably 0,3 to 0,7% by weight tin. In addition to tin, the copper tin alloy can naturally also contain incidental constituents and impurities. The electrical contact element is used in alkaline cells preferably in a form of a nail, which is achieved by cutting a metal profile, such as a wire, having the desired composition. The cross-section of the electrical contact element is preferably circular, but the cross-section of the element can also be for instance quadratic, quadrangular or triangular or even polygon.

The electrical contact element is preferably used in alkaline electrochemical cells wherein a cathode material is so shaped that the cathode material forms a casing for the cell. The cavity of this preferably cylindrical cathode is fitted with a separator material and the separator-lined cavity is filled with an anode material. The open end of the casing is provided with a cover having a centrally located hole through which hole the electrical contact element is fitted into the anode material. The casing is preferably cylindrical, but the casing can also be for instance flat.

The electrical contact element of the invention made of a tin alloyed copper alloy has a lower resistivity than materials used in the prior art. Based on the lower resistivity essentially the same cell performance and life-time can then be achieved with a smaller cross-section of the electrical contact element. The electrical contact element having a smaller cross-section allows produce the same number of alkaline cells with less metal costs.

The metal costs are one reason to use the electrical contact element having a smaller cross-section. It is also that the less metal is needed the less metal goes to the landfills where main part of alkaline cells end up after their use. A smaller cross-section has thus also an environmental advantage. Further, when comparing the electrical contact element of the invention with the electrical contact element made of a material in the prior art, the life-time of the electrical contact element is lengthened because in the tin alloyed copper alloy of the invention the migration of zinc alloyed in the brass material is prevented.

The effect of resistivity in the electrical contact element can be calculated by the formula (1)

$$R = \frac{ρ \times L}{A} , \qquad ( 1 )$$

wherein R is a resistance for direct current, ρ is the resistivity for a connector, L is the length of the connector and A is the cross-section area of the connector. A formula (2) for the resistivity ρ can be calculated from the formula (1)

$$ρ = \frac{R \times A}{L} . \qquad ( 2 )$$

Using the formula (2) for the resistivity p the properties of a wire with 0,5% by weight tin for the electrical contact element of the invention is compared with the properties of a wire for the electrical contact element made of a brass (C26001). The results are enlisted in the following table:

Alloy

| | Brass (C26001) | Copper tin alloy |
|---|---|---|
| Resistivity ρ (Ω/m) | 6.42E−08 | 2.47E−08 |
| Length L (m) | 1 | 1 |
| Resistance R (Ω) | 0.061 | 0.061 |
| Cross-section area A | 1.04901E−06 | 4.04386E−07 |
| (m²) | | |
| Wire diameter (mm) | 1.1557 | 0.7176 |

The comparison was made so that the resistance R and the length L for both materials were the same because when the resistance R is the same the same amount of direct current will flow through the connectors. However, because the resistivities for the material used in the electrical contact element of the invention and in the material of the prior art are different, the same resistance will be achieved by changing the cross-section area of the elements. As seen from the table, the wire diameter for the alloy used in the electrical contact element of the invention is only about 62% from the wire diameter for the alloy used in the prior art.

1. Electrical contact element for an alkaline electrochemical cell, the electrical contact element consisting essentially of a copper tin alloy.

2. Electrical contact element of claim 1, wherein the electrical contact element contains 0.05-1.5% by weight tin.

3. Electrical contact element of claim 2, wherein the electrical contact element contains 0.3-0.7% by weight tin.

4. Electrical contact element of claim 1, wherein the electrical contact element has a circular cross-section.

5. Electrical contact element of claim 1, wherein the electrical contact element has a quadratic cross-section.

6. Electrical contact element of claim 1, wherein the electrical contact element has a quadrangular cross-section.

7. Electrical contact element of claim 1, wherein the electrical contact element has a polygon cross-section.

8. The use of a copper tin alloy as an electrical contact element in an alkaline cell.
